(19) United States
(12) Patent Application Publication
(10) Pub. No.: US 2014/0040389 A1
(43) Pub. Date: Feb. 6, 2014

(54) PHASED DELIVERY OF PUBLICATIONS TO SUBSCRIBERS

(71) Applicant: INTERNATIONAL BUSINESS MACHINES CORPORATION, ARMONK, NY (US)

(72) Inventors: ANTHONY P. BEARDSMORE, WINCHESTER (GB); JONATHAN LEVELL, WINCHESTER (GB); MATTHEW R. WHITEHEAD, WINCHESTER (GB)

(21) Appl. No.: 13/937,606

(22) Filed: Jul. 9, 2013

(30) Foreign Application Priority Data
Aug. 3, 2012 (GB) 1213829.3

(51) Int. Cl. H04L 12/58

(52) U.S. Cl. CPC H04L 51/00
USPC 709/206

(57) ABSTRACT

A method, system, and/or computer program product controls a transmission of messages to subscribers in a publish/subscribe messaging network. One or more processors receives a message delivery requirement for a published message, where the message delivery requirement describes delivery parameters for each of a plurality of subscribers in a publish/subscribe messaging network. One or more processors then controls a delivery of the published message to each of the plurality of subscribers in accordance with the message delivery requirement, where said delivery is initiated to at least some of the set of subscribers at different times in order to comply with the message delivery requirement.

This application is based on and claims the benefit of priority from Great Britain (UK) Patent Application 1213829.3, filed on Aug. 3, 2012, and herein incorporated by reference in its entirety.

### BACKGROUND

The present invention relates to computing systems, and deals more particularly with phased delivery of publications to subscribers in a publish/subscribe messaging environment.

Publish/subscribe messaging systems are known in the art for publishing messages in computing environments, and provide an effective way of disseminating information to multiple users. Publish/subscribe messaging enable messages to be published to a potentially large, widespread and dynamically changing audience in a timely manner. Typically, the message publishers are not concerned with where their messages are sent, and the subscribers are not concerned with where the messages originate. Instead, an intermediary commonly referred to as a message broker is typically responsible for receiving messages from publishers, consulting previously-registered subscription information associated with the subscribers to determine which subscribers should receive the published messages, and then forwarding the messages to the appropriate subscribers according to the registered subscriptions.

Publish/subscribe solutions are typically implemented together with messaging systems in a distributed computing network, but the messaging network may be any suitable network such as a packet switched network. The size of such messaging networks continues to increase, so the messaging network is built up from increasingly large numbers of devices that compete for available communication bandwidth. For example, it is now possible for a single publication to be distributed to millions of subscribers. With this scale of distribution, publications can saturate the resources of the messaging network, and may use valuable resources such as communication bandwidth and CPU processing time even if the publication is not particularly urgent.

In addition, such a wide distribution means that any error or mistake in a message can have wide reaching consequences. For example, a message in which updated firmware containing a bug is distributed to a large number of subscribers can adversely affect all of these subscribers.

Typically, upon receipt of a message with a publish instruction, a publish/subscribe system will attempt to deliver the message simultaneously to all subscribers that are registered for receipt of this message. This can rapidly lead to network resource saturation. Furthermore, this simultaneous approach to message delivery is inflexible.

### SUMMARY

A method, system, and/or computer program product controls a transmission of messages to subscribers in a publish/subscribe messaging network. One or more processors receives a message delivery requirement for a published message, where the message delivery requirement describes delivery parameters for each of a plurality of subscribers in a publish/subscribe messaging network. One or more processors then controls a delivery of the published message to each of the plurality of subscribers in accordance with the message delivery requirement, where said delivery is initiated to at least some of the set of subscribers at different times in order to comply with the message delivery requirement.

Further details of the phased delivery are set out in the following detailed description.

### BRIEF DESCRIPTION OF THE SEVERAL VIEWS OF THE DRAWINGS

Embodiments of the present invention are described below, by way of example only, with reference to the following drawings in which:

FIG. 1A illustrates components which may be used with any embodiment described herein;

FIG. 1B illustrates an exemplary data processing system which may be used with any embodiment described herein; and

FIGS. 2-5 provide flowcharts depicting logic which may be used when implementing one or more embodiments of the present invention.

### DETAILED DESCRIPTION

As will be appreciated by one skilled in the art, aspects of the present invention may be embodied as a system, method, computer program product or computer program. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Java and all Java-based trademarks and logos are trademarks or registered trademarks of Oracle and/or its affiliates.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

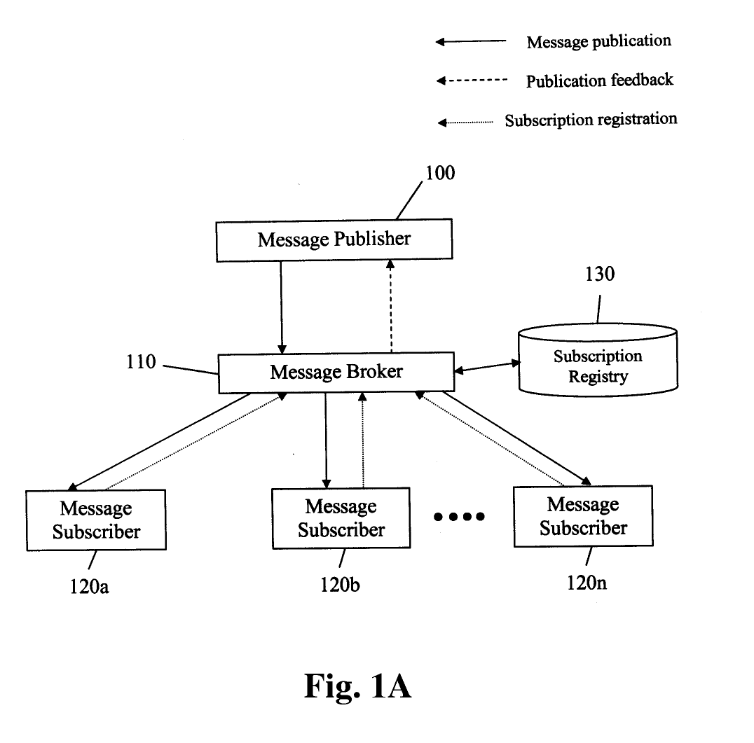

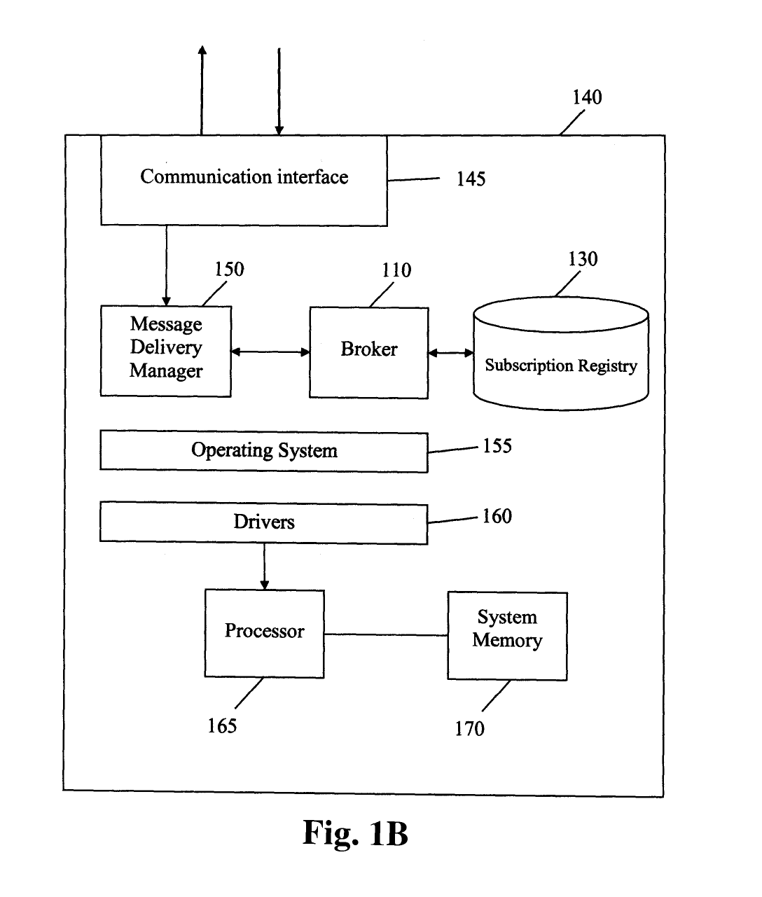

Components in one embodiment of a system that provides message publication control and feedback, as disclosed herein, will now be described with reference to FIGS. 1A and 1B.

Components shown in FIG. 1A comprise a message publisher 100; a message broker 110; several message subscribers 120a, 120b . . . 120n; and a subscription registry 130. One or more of the components shown in FIG. 1A may be included in a messaging system in which embodiments of the present invention are implemented. These components will now be described in more detail.

Message publisher 100 publishes messages to message broker 110. The message publisher 100 may be an application program making API calls to invoke a message transmission operation by a messaging manager running on the same data processing system as the publisher 100. Messages typically comprise a body part containing the message content or “payload” and a header part containing metadata that is needed for message routing and delivery across the network to appropriate recipients. However, as used herein the term message is intended to include an entity containing information that is transmitted from a source (typically a publisher application's data processing system) to a consumer (typically a subscriber application), either directly or via intermediate network nodes. The content or payload of the message may be text, one or more images and/or videos, human readable computer code (‘source code’), machine readable computer code, one or more software applications, or any combination of the aforementioned. This list is non-exhaustive and messages described herein may include other types of content not explicitly listed here. Messages may be transmitted in encrypted or unencrypted form. A publish/subscribe message broker may rely on details in a message header for its subscription matching, or a broker may inspect the message contents for subscription matching.

FIG. 1B shows an exemplary data processing system 140 that may be used to implement any embodiments described herein. Data processing system 140 includes a communications interface 145 that allows data processing system 140 to communicate with other data processing systems or devices and/or message publisher 100 via a network such as a packet switched network. Communications interface 145 may comprise, for example, a wired or wireless Ethernet adaptor. Communicatively coupled to communications interface 145 is a message delivery manager 150 that handles receipt and delivery of messages on behalf of publish/subscribe broker such as message broker 110. Message delivery manager 150 may be integrated with, or interface to, message broker 110 and can make use of existing network transfer services such as TCP/IP and SNA. The exemplary data processing system 140 of FIG. 1B includes a subscription registry 130, although it is not essential for subscription registry 130 to be located on the same data processing system 140.

As shown in FIG. 1B, data processing system 140 has an associated operating system 155 that coordinates the operation of data processing system 140 and facilitates the execution of one or more application programs on data processing system 140. One or more drivers 160 are provided to allow operating system 155 to interact with and control the hardware components of data processing system 140. These hardware components include processor (CPU) 165 and system memory 170. Data processing system 140 may include other hardware components not shown in FIG. 1B, including but not limited to one or more permanent storage devices such as a hard disk drive (HDD) or an optical drives such as a CD or DVD drive, a display device such as a monitor or a flat panel display and/or one or more input devices such as a computer mouse or keyboard to provide a means for data processing system 140 to receive human input.

The broker functionality includes identification of relevant subscribers to receive a published message; and the message delivery functionality includes transmission of messages to, and typically also verification of successful receipt of messages by, another data processing apparatus on route to an identified subscriber or group of subscribers.

Each published message may have one or more associated topics. Each subscriber 120a, 120b, . . . 120n registers one or more subscriptions with message broker 110. Each subscription may specify one or more topics. Message broker 110 maintains these subscriptions in subscription registry 130, which may be a database or other persistent store. Upon receiving a message from publisher 100, message broker 110 may consult the subscription registry 130 when determining whether to send the message to subscribers 120a, 120b, . . . 120n.

Although a single message publisher 100 is depicted in FIG. 1A, it will be understood that this is by way of illustration only, and an actual implementation of the present invention may support a number of concurrently-active message publishers. Equally, the present invention may be implemented over a messaging network comprising many publishers similar to message publisher 100 and/or many brokers similar to broker 110.

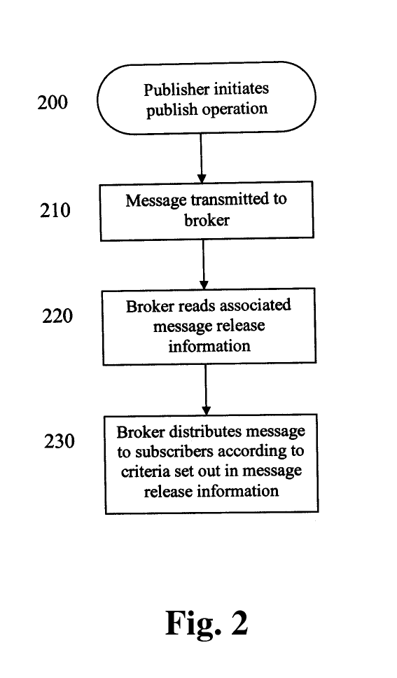

Referring now to FIG. 2, a flowchart is provided depicting logic suited for use with embodiments described herein which may be used when publisher 100 initiates a publish operation to publish a message.

Firstly, in step 200, publisher 100 initiates a publish operation. In the present embodiment publisher 100 is an application program running on a data processing device, but this is not essential to the working of the invention and other types of publisher may also be used without departing from the scope of the invention.

As shown in step 210, a publication operation involves publisher 100 interfacing with a messaging manager to transmit a message. By way of example only, in the present embodiment, the publisher's messaging manager transmits a published message to another messaging manager that is associated with a publish/subscribe broker 110. The broker may be located at an intermediate network node (or may be part of a distributed broker network) between publishers and subscribers. However, it is also possible for the subscription matching functions of a message broker to be implemented on the same system as a publisher application (i.e. each publisher system identifies the destinations for its publications) or on the same system as a receiver application (i.e. each subscriber system identifies which of its local applications should process a received publication and which received publications should be discarded). In the present embodiment publisher 100 may send the message directly to broker 110, or the message may be sent via one or more intermediate network components.

The message sent by publisher 100 to broker 110 may include one or more pieces of information. In one example the message includes a topic. This topic may be specified by publisher 100. Broker 110 may use this topic to determine which of subscribers 120a, 120b . . . 120n should receive the message. Broker 110 may consult subscription registry 130 when determining which of subscribers 120a, 120b . . . 120n to send the message to. Broker 110 may send the message to one or more of subscribers 120a, 120b . . . 120n. The message may be sent directly from broker 110 to one or more of subscribers 120a, 120b . . . 120n, or it may be sent via one or more additional network components, possibly including one or more additional brokers similar to broker 110. Each network component, including broker 110, may be required to confirm receipt of the message before forwarding in to the next network component. This receipt may be sent back to the immediately preceding network component as a confirmation that the message was received. A network component not receiving a confirmation may attempt to re-send the message. The re-send operation may be attempted only after a predefined time period has passed.

One or more of subscribers 120a, 120b . . . 120n may be required to confirm receipt of the message once they have received it. This receipt may be sent back to publisher 100 as a confirmation that the message was delivered to the subscriber in question.

In the present embodiment, when the message is sent by publisher 100 to broker 110, publisher 100 also sends a piece of information to broker 110 referred to herein as the ‘message distribution information’. This may be contained in the message itself, or it may be transmitted separately. The message distribution information may be set by publisher 100. Alternatively, the message distribution information may be configured in other ways without deviating from the scope of the present invention, including through an administrative interface.

The function of the message distribution information is to specify that delivery of the message to subscribers 120a, 120b . . . 120n is to be attempted in stages or ‘phases’, with each stage being separated from the others in time. This is explained in the following portion of this detailed description.

Upon receipt of a message, in step 220 broker 110 reads at least the message distribution information associated with the message. The message distribution information specifies that the message is to be delivered in stages and also provides a definition of how the stages are defined or demarcated. In step 230 broker 110 distributes the message to according to the criteria set out in the message distribution information. For simplicity, in the following discussion it is assumed that all of subscribers 120a, 120b . . . 120n are intended recipients of the message, but this is purely exemplary and any number ranging from one to all of the subscribers from the set of subscribers 120a, 120b . . . 120n may be the intended recipients.

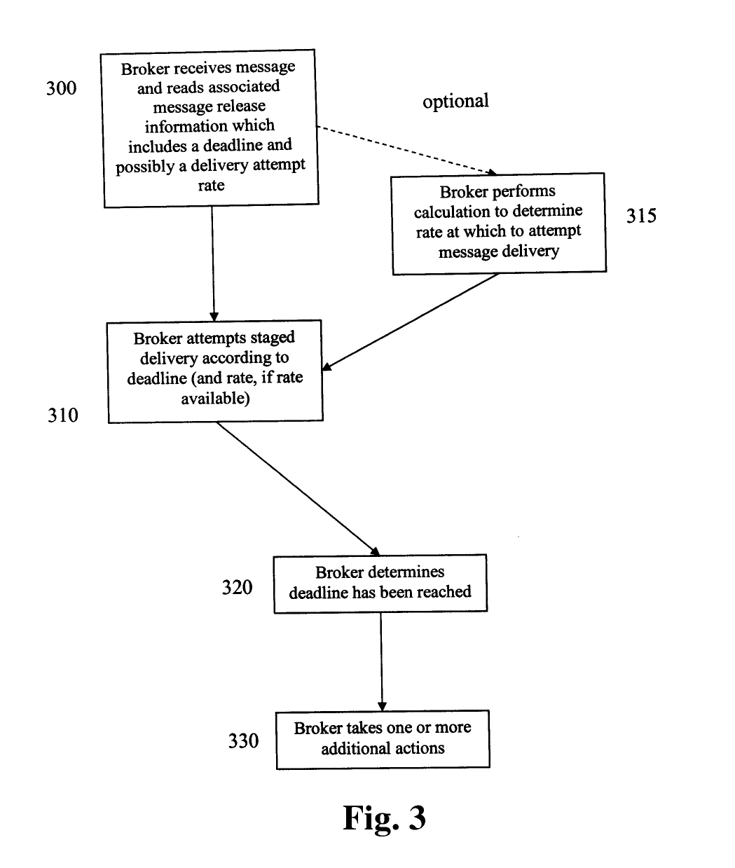

In one embodiment shown in FIG. 3 the message distribution information specifies a ‘deadline’ by which broker 110 must have attempted delivery of the message in question to all of the subscribers 120a, 120b . . . 120n that are the intended recipients of the message. The deadline may be specified as a fixed point in the future (e.g. 12:00 AM, 24 Apr. 2012) or it may be specified relative to the time at which broker 110 first received the message (e.g. 4 hours from receipt).

In this embodiment, in step 300 broker 110 receives a message for publication from publisher 100 and reads the message distribution information associated with said message that specifies at least a deadline for attempting delivery of a message. In step 310 broker 110 then initiates an attempt to distribute the message to subscribers 120a, 120b . . . 120n gradually until the deadline is reached. As shown in optional step 315 before attempting delivery broker 110 may carry out a calculation to work out a rate at which message delivery attempts should be made to ensure that delivery to all subscribers has been attempted by the deadline. This calculation may be based on one or more of the time available until the deadline, the number of subscribers and/or the average time taken to attempt a message delivery. Other relevant factors may also be taken into consideration when performing the calculation. When a calculation is made broker 110 attempts delivery of the message at the rate specified by the calculation. The rate may be static or it may be dynamic. Broker 110 may periodically re-perform the calculation during the publication operation in order to adjust the rate of attempted delivery.

As an alternative, the rate at which delivery attempts should be made may be specified in the message distribution information associated with the message. This may be set by publisher 100 or some other entity such as a system administrator. This rate may be static or it may be dynamic.

In step 320 broker 110 determines that the deadline has been reached and then in step 330 broker 110 takes one or more additional actions. Examples of possible additional actions are described in the following paragraph of this specification and it is contemplated that the skilled person having the benefit of this disclosure will be able to determine other appropriate additional actions.

As a first example of an additional action broker 110 may attempt a simultaneous delivery to all subscribers for which a delivery had not been attempted. In addition to or instead of a simultaneous delivery attempt broker 110 may report back to publisher 100 that an attempt at message delivery to all of subscribers 120a, 120b . . . 120n could not be made before the deadline and may request further instructions from publisher 100. Alternatively, broker 110 may take no further action in step 330 and simply cease initiation of delivery attempts. This may be reported back to publisher 100.

The message distribution information may specify, in addition to a deadline and/or a delivery rate, the one or more additional actions to take in step 330 if the deadline is reached before an initiation of an attempt to deliver the message to all of subscribers 120a, 120b . . . 120n has been made. The one or more additional actions may be as described in the preceding paragraph and may include initiating a simultaneous delivery to all subscribers for which a delivery had not yet been initiated.

At any time during the publish operation broker 110 may be responsive to a request from publisher 100 to stop making delivery attempts. Delivery attempts may be stopped permanently or temporarily. In the event a stop initiating delivery request is received, broker 110 may report back to publisher 100 with a list of all of the subscribers for which delivery has not yet been initiated or attempted, and/or with a list of all of the subscribers for which delivery has been initiated or attempted. The latter list may indicate any and all subscribers that confirmed receipt of the message.

One advantage of the staged approach to attempted delivery of this embodiment is that, in the event an error is discovered in a message for which distribution has begun, it is possible to recall the message before it is delivered to all of subscribers 120a, 120b . . . 120n. This may be particularly important in a case where the message includes a software update or a firmware update, as an error in updates of this type can cause one or more of data and/or functionality loss for the recipient subscribers, possibly requiring the entity responsible for publishing the error containing message to take costly corrective action.

Equally a text based message may benefit from the staged approach to attempted delivery of this embodiment, as e.g. distributing an incorrect date for an event to a large number of individuals can result in confusion that is time consuming to deal with.

In addition, the staged delivery prevents the messaging network being overloaded by a large number of simultaneous delivery attempts. This is particularly important in the case of a large number of subscribers 120a, 120b . . . 120n or in a messaging network with limited capacity and/or resources.

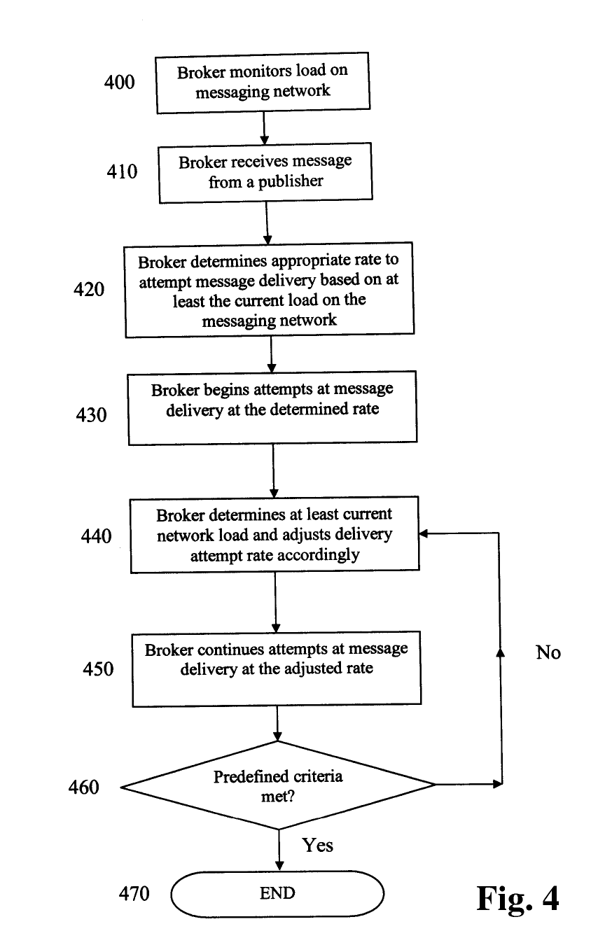

In another embodiment shown in FIG. 4 broker 110 is configured to monitor the activity of the messaging network and to adjust the rate of attempted delivery according to the load on the messaging network.

As shown in step 400, broker 110 monitors the activity of the messaging network. This monitoring may be conducted in substantially real time.

The load on the messaging network may be defined as the availability of network resources such as, for example, available bandwidth, available memory and/or available CPU cycles. Broker 110 may monitor the load on the messaging network via a software application configured for such a purpose, as is known in the art. Other known means for monitoring the load on a network are also contemplated for use in this embodiment. Broker 110 may not carry out the network monitoring itself and may instead be receiving information about the messaging network activity from another source such as another device in the messaging network.

In step 410 broker 110 receives a message from publisher 100 and in step 420 broker 110 determines an appropriate rate at which to attempt message delivery based on at least the current load on the messaging network. In step 430 broker 110 begins attempting delivery of the message to subscribers 120a, 120b . . . 120n at the rate determined in step 420. In step 440 broker 110 adjusts the rate at which to attempt message delivery according to changing load conditions on the messaging network.

As an example of a contemplated adjustment, broker 110 may increase the rate of attempted delivery when it determines that the messaging network is lightly loaded and has spare capacity and decrease the rate of attempted delivery when it determines that the messaging network is heavily loaded and has little spare capacity. Broker 110 may define threshold levels denoting situations such as ‘light loading’, ‘heavy loading’ and these may be defined by one or more of the percentage of available bandwidth in the messaging network, the percentage of available memory in the messaging network and/or number of available CPU cycles in the messaging network. Other criteria such as latency may also be used. The threshold levels may be set by an appropriate authority such as a system administrator or they may be determined by broker 110. The threshold levels may be specified in the message distribution information. The threshold levels may be static or dynamic.

In an alternative embodiment, an equation or set of equations specifying the rate of attempted delivery as a function of one or more network loading criteria such as available bandwidth, available memory and/or available CPU cycles may be used by broker 110 to calculate a dynamic rate of attempted delivery. This may be used in place of or in addition to threshold levels described previously. This equation or set of equations may be specified in the message distribution information.

In an extreme case, broker 110 may attempt to deliver the message simultaneously to all or substantially all of the subscribers 120a, 120b . . . 120n in response to detection of spare capacity in the messaging network. This may correspond to a ‘no load’ threshold condition. Conversely, if the messaging network is very heavily loaded, broker 110 may temporarily suspend attempts to deliver the message to subscribers 120a, 120b . . . 120n. This may correspond to a ‘maximum load’ threshold condition.

In step 450 broker 110 continues attempts at message delivery at the new rate determined in step 440. This new rate may be anywhere between zero (i.e. stop attempting delivery) and ‘all at once’, where an attempt to deliver the message to all remaining subscribers simultaneously is made.

In step 460 a determination is made of whether one or more predefined criteria have been met, to enable the broker 110 to end the message publication operation. If they have not, broker 100 returns to step 440 and adjusts the rate at which to attempt message delivery according to the current load conditions on the messaging network. If the one or more predefined criteria have been met, broker 110 ends the message publication operation in step 470. Examples of the type of predefined criteria that may be used include determining if a delivery attempt has been made to all of subscribers 120a, 120b . . . 120n; i.e. determining that the publication operation is complete. Another criteria that may be used is a deadline as described earlier in connection with the embodiment shown in FIG. 3. Broker 110 may take account of this deadline as well as messaging network loading when determining an appropriate rate to attempt message delivery in step 420 and/or step 440. Another criterion may be availability of a next update message—for example if the broker is able to associate two messages NewsUpdate1 and NewsUpdate2, a rule can be implemented to cease delivery attempts for NewsUpdate1 when the broker starts delivering NewsUpdate2.

One advantage of the staged approach to attempted delivery of this embodiment is that network resources can be more effectively used. This is particularly advantageous in a situation where a message is to be distributed to a large number of subscribers, as a simultaneous attempt at delivery may overwhelm the resources of the messaging network due to the sheer number of subscribers. The staged approach to attempted delivery of this embodiment is also particularly suited for use in a network having irregular and/or unpredictable usage characteristics, as this embodiment can make use of the ‘lulls’ in activity on such a network to avoid overloading the network at busy times.

In any of the embodiments described herein the message distribution information may specify one or more additional parameters that are used by broker 110 when determining a publication rate and/or publication strategy. Examples of additional parameters that may be specified in the message distribution information associated with a message that is distributed according to any of the embodiments described herein are provided in the following paragraphs. The parameters in the message distribution information may be set by publisher 100 or by another entity such as a system administrator. Any combination of the aforementioned parameters and/or any other suitable parameter may be specified in the message distribution information.

The message distribution information may include a batch value which specifies that one or more simultaneous or high priority delivery attempts should be made to a group of subscribers. The group comprises a subset of the total subscribers 120a, 120b . . . 120n. A subset of subscribers may be defined using one or more of subscriber location or subscriber importance (e.g. subscriber sub-level value), instead of or in addition to any other appropriate subscriber or network parameter or parameters, to form a subscriber subset for which delivery will be attempted together. Subscribers may also be grouped according to characteristics of their available network communications—for example to differentiate between mobile subscribers and those with faster and more reliable network links.

The message distribution information may additionally include a batch interval which specifies a time interval between attempting delivery of the message to each subset of subscribers. The message distribution information may specify one or more conditions that must be met before an attempt to deliver to the next group of subscribers is made.

One advantage of this batch type delivery is that a message can be delivered to a large number of subscribers relatively quickly, or to a high priority subset, but without the possibility of overloading the messaging network as may occur if a delivery attempt is made simultaneously to all of subscribers 120a, 120b . . . 120n. The high priority subset of subscribers may be network nodes that comprise onward distribution capabilities, such as broker capabilities. Prioritization of intermediate nodes in a broker network can provide fast distribution throughout a distributed broker network (to avoid delays at multiple points in the network) and yet retain the benefit of local brokers being able to manage phased delivery to their subscribers as described above. This can involve a broker-implemented rule where a broker has initial responsibility for distribution of messages to a set of subscribers, subject to a condition that the broker's responsibility has been met if the message

The message distribution information may specify a delivery order in which delivery attempts should be made. Delivery attempts may be ordered by subscriber parameters such as subscriber location (obtained via e.g. IP address lookup) or subscriber importance. A message delivery order may be specified according to a subscriber importance level, with monitoring of successful delivery to certain subscribers. Alternatively, the delivery order could be random, or based on a subscriber action or status, such as online/offline status.

More than one of any of the aforementioned parameters may be defined in the message distribution information for used in combination in a particular message delivery attempt.

As one illustrative embodiment, a phased delivery involves identifying subscriber groups by subscribers' network locations, and the delivery order is specified by subscriber group. The result is that staged delivery attempts are made, with each stage corresponding to an attempt to deliver to a group of geographically proximal subscribers.

As another illustrative embodiment, the message distribution information specifies a batch value and a condition. In this illustrative embodiment the condition encodes the logic ‘do not attempt delivery to the next group until at least n % subscriber reboot has occurred’, where n is a number between 0 and 100 set by e.g. publisher 100 or a system administrator.

Each subscriber in the group has associated with it a reboot status. This may be in the form of a flag that is set to FALSE if the subscriber has not rebooted since the delivery attempt has been made and TRUE if the subscriber has rebooted since the delivery attempt has been made. The logic of the condition is such that broker 110 will not attempt to deliver the message to the next group of subscribers until it has received confirmation that at least n % of the subscribers in the first group have rebooted. Once broker 110 has received this confirmation, it may proceed to attempt delivery to the next group of subscribers, or it may proceed to attempt delivery to all of the remaining subscribers from the full subscriber set 120a, 120b . . . 120n. If broker 110 does not receive this confirmation, possibly after a predefined time period, it may cancel the delivery attempt to the remaining subscribers from the full subscriber set 120a, 120b . . . 120n and may inform publisher 100 of this cancellation.

It will be appreciated that this embodiment is particularly suited for distributing messages containing firmware updates and the like, where each subscriber has the potential to be adversely affected by any errors in the message. In particular this embodiment and its variants allow a publisher to ‘test’ a message on a group of subscribers to check that it performs as expected before releasing it to the full subscriber set. In the case that one or more errors are found, the publisher may be able to request additional information from all of the affected devices in order to determine an appropriate fix. This is a particularly efficient way for a publisher to conduct a ‘real world’ test of a message using a group of subscribers without risking negative consequences for the entire subscriber set 120a, 120b . . . 120n.

It is contemplated that a rules engine could be used to implement any of the embodiments described herein. The message distribution information may be fed into the rules engine, possibly instead of or in addition to information about the current loading of the messaging network and/or the status of subscribers 120a, 120b . . . 120n. The rules engine may then determine an appropriate message delivery strategy formed of one or more of the message delivery strategies described herein and/or any other suitable message delivery strategies and it may then cause broker 110 to proceed with attempting delivery according to the selected strategy. The rules engine may be executing on broker 110, or it may be running on a separate network component including publisher 100.

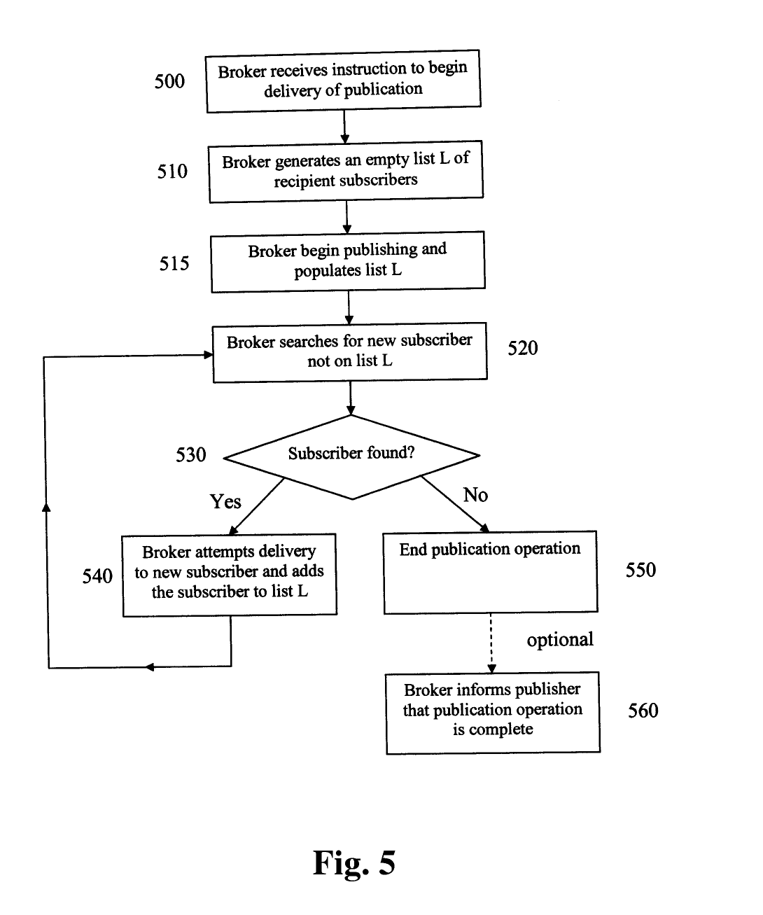

In many of the staged publication embodiments described herein attempting to deliver the message to all of subscribers 120a, 120b . . . 120n will take a significant time period. Used herein a significant time period is one in which it is possible for new subscribers to register with the messaging network; i.e. during the publication process itself. With reference to FIG. 5, a method according to an embodiment of the invention is described which deals with the situation where at least one new subscriber registers with the messaging network after publisher 100 has initiated a publish operation but before the delivery operation has completed. This method is suited for use with any of the previously described embodiments.

In step 500 broker 110 receives an instruction to begin distribution of a published message to a set of subscribers such as subscribers 120a, 120b . . . 120n. The instruction may originate from publisher 100. The set of subscribers 120a, 120b . . . 120n is updated to include a new subscriber every time a new subscriber joins the messaging network and this updated set of subscribers is available to broker 110.

Following receipt of the publication instruction, in step 510 broker 110 generates a subscriber list L for that publication. This may involve generating 510 an empty list, and populating 515 the empty list with the subset of subscribers (120a, 120b, . . . ) that the broker identifies as being relevant to the published message. In step 520, such as when the messaging manager is ready to deliver to another subscriber or group of subscribers, broker 110 searches its subscriber set for a subscriber that is not on list L, and in step 530 makes a determination whether a subscriber in subscriber set 120a, 120b . . . 120n that is not on list L has been found. If a subscriber that is not on list L has been found, in step 540 broker 110 attempts to deliver the message to the subscriber in question and adds the subscriber to list L. Any suitable unique identifier may be used in list L to identify a subscriber, such as subscriber IP address.

Steps 520-540 are then repeated until in step 530 broker 110 determines that there are no subscribers that are in subscriber set 120a, 120b . . . 120n that are not on list L. Broker 110 then determines that the publication operation is complete in step 550. In optional step 560 broker 110 may inform publisher 110 that it has determined that the publication operation is complete, and it may transmit list L to publisher 110. List L may additionally identify any subscribers that indicated to broker 110 that they had received the message whilst the publication operation was ongoing.

In an alternative embodiment, broker 110 repeats steps 520-540 until the earliest of (a) no subscriber in subscriber set 120a, 120b . . . 120n that is not on list L can be found or (b) a predefined time period expires. In this embodiment, broker 110 may transmit list L to publisher 100 if it determines that the predefined time period has expired before a delivery attempt to all of subscriber set 120a, 120b . . . 120n could be made.

As a further alternative embodiment, subscriber set 120a, 120b . . . 120n may be fixed at the time broker 110 receives an instruction to begin publication of a message. In this embodiment broker 110 will not attempt delivery to any subscribers joining the messaging network after it receives the instruction to begin publication of a message.

In one embodiment of the invention it is possible, at any time during the publication process, to request a publication status from broker 110. This request may be transmitted by publisher 100 and it may include a unique identifier such as a series of alphanumeric characters that identifies the publication to broker 110. In response to such a publication status query, broker 110 provides the current status of the publication operation, which may include one or more of the number of subscribers for which delivery has been attempted, the percentage of subscribers for which delivery has been attempted, the number of subscribers that have acknowledged receipt of the message, an estimated time remaining until publication is complete, and/or any other relevant information.

In addition to the publication status request, it may be possible for publisher 100 to transmit a ‘cancel publication’ request to broker 110. This may include a unique identifier (of the type described previously for status requests) to identify the publication to broker 110. On receipt of a cancel publication request, broker 110 stops attempting delivery to subscribers 120a, 120b . . . 120n. Broker 110 may inform publisher 100 that it has stopped attempting delivery and it may transmit to publisher 100 a list of all subscribers for which had already attempted delivery before it received the cancel publication request. If the facility is available in the messaging network, broker 110 may also attempt to remove the message from any subscriber that had not yet processed it.

The inventors of the present invention have provided a publish/subscribe messaging system in which it is possible to distribute a message to a set of subscribers over a period of time, instead of always sending messages to all subscribers simultaneously.

In a first aspect, the invention provides a messaging manager, for use in a publish/subscribe messaging network, that is responsive to message delivery requirements for a received published message to control transmission of the message to a plurality of subscribers in accordance with the message delivery requirements, such that delivery is initiated to at least some of the plurality of subscribers at different times when required by the message delivery requirements.

In one embodiment, the messaging manager provides logic, which may be implemented in computer program code, for: identifying message delivery requirements for a received published message; setting message delivery parameters for each of the plurality of subscribers corresponding to the message delivery requirements; and controlling message delivery initiation in accordance with the message delivery parameters.

In a second aspect, the invention provides a method for controlling transmission of messages to subscribers in a publish/subscribe messaging network, comprising: identifying message delivery requirements for a published message; and performing a phased transmission of the message to a plurality of subscribers in accordance with the message delivery requirements, such that delivery is initiated to at least some of the plurality of subscribers in phases at different times, when required by the message delivery requirements.

In one embodiment, an application program performing a publish operation can specify message delivery requirements that are used by a messaging manager to control a phased transmission of a message to subscribers, such that the message is sent to different subscribers at different times. In other embodiments, a messaging manager checks messaging network communication parameters (such as current load conditions or available bandwidth) before delivering a message to subscribers, and performs a phased-delivery when required by the current network communication parameters.

Viewed from a further aspect, the present invention provides a computer program product for use in a publish/subscribe messaging network, the computer program product comprising: a computer readable storage medium readable by a processing circuit and storing instructions for execution by the processing circuit for performing a method for performing the steps of the invention.

Viewed from a further aspect, the present invention provides a computer program stored on a computer readable medium and loadable into the internal memory of a digital computer, comprising software code portions, when said program is run on a computer, for performing the steps of the invention.

Viewed from a further aspect, the present invention provides a method substantially as described with reference to figures.

Viewed from a further aspect, the present invention provides a system substantially as described with reference to figures.

The inventors have determined that delivery of messages in phases that are separated in time, or otherwise enabling delivery initiation or attempts to be handled with time flexibility within a defined period of time, offers various improvements over known publish/subscribe solutions that attempt to send a message to all subscribers simultaneously. The invention is applicable to a phased delivery of a firmware update.

It will be appreciated by a person skilled in the art having the benefit of this disclosure that the embodiments described herein are not restricted for use with any particular application or class of applications, or with any particular types of message, messaging network or operating system.

In addition to the embodiments described in detail above, the skilled person will recognize that various features described herein can be modified and combined with additional features. Steps of all methods and processes described herein may be performed out of order, in parallel or consecutively, and some steps may be omitted entirely. Such variations are intended to be within the scope of the present invention.

1. A method for controlling a transmission of messages to subscribers in a publish/subscribe messaging network, the method comprising:
receiving, by one or more processors, a message delivery requirement for a published message, wherein the message delivery requirement describes delivery parameters for each of a plurality of subscribers in a publish/subscribe messaging network; and
controlling, by one or more processors, a delivery of the published message to each of the plurality of subscribers in accordance with the message delivery requirement, wherein said delivery is initiated to at least some of the set of subscribers at different times in order to comply with the message delivery requirement.

2. The method of claim 1, wherein the published message includes a firmware update, and wherein the method further comprises:
comparing, by one or more processors, the published message with subscription information to identify a set of subscribers to receive the published message; and
performing phased distribution of the published message.

3. The method of claim 1, wherein control of delivery of the published message comprises a phased transmission such that delivery initiation to a first subset of subscribers is performed at a separate time from delivery initiation to a second subset of subscribers.

4. The method of claim 3, wherein the first subset of subscribers and the second subset of subscribers comprise separate groups of subscribers that are grouped according to their locations in the publish/subscribe messaging network.

5. The method of claim 3, wherein the first subset of subscribers and the second subset of subscribers comprise separate groups of subscribers that are grouped according to available resources on the publish/subscribe message network.

6. The method of claim 3, wherein delivery of the published message to the second subset of subscribers is initiated in response to a successful delivery of the published message to the first subset of subscribers.

7. The method of claim 1, further comprising:
determining, by one or more processors, whether a predetermined percentage of subscribers in a publish/subscribe messaging network has rebooted their computers within a predefined time period; and
in response to determining that the predetermined percentage of subscribers in a publish/subscribe messaging network has not rebooted their computers within the predefined time period, cancelling delivery of the published message to subscribers for which message delivery has not yet successfully completed.

8. The method of claim 1, further comprising:
further controlling, by one or more processors, the delivery of the published message to each of the plurality of subscribers in accordance with a loading level of the publish/subscribe messaging network, wherein a rate of attempted delivery of the published message to different subscribers increases in response to the messaging network having spare capacity beyond a predetermined level, and wherein a rate of attempted delivery of the published message to different subscribers decreases in response to the messaging network having spare capacity below the predetermined level.

9. The method of claim 1, wherein the message delivery requirement defines a deadline for delivering the published message to all of the plurality of subscribers.

10. The method of claim 1, wherein a publish/subscribe message broker interfaces between the messaging publish/subscribe network and subscriber application programs, and wherein the method further comprises the publish/subscribe message broker:
checking, by one or more processors, message delivery requirements for a received published message;
determining, by one or more processors, required times for delivery initiation of the published message;
inspecting, by one or more processors, a message header in the published message, wherein the message header comprises one or more message topic fields and one or more message delivery requirement fields;
comparing, by one or more processors, contents of the one or more message topic fields with a subscription list to identify subscribers; and
determining, by one or more processors, required times for delivery initiation for identified subscribers based on contents of the one or more message delivery requirement fields.

11. A computer program product for controlling a transmission of messages to subscribers in a publish/subscribe messaging network, the computer program product comprising a tangible computer readable storage medium having program code embodied therewith, the program code readable and executable by a processor to perform a method comprising:
receiving a message delivery requirement for a published message, wherein the message delivery requirement describes delivery parameters for each of a plurality of subscribers in a publish/subscribe messaging network; and
controlling a delivery of the published message to each of the plurality of subscribers in accordance with the message delivery requirement, wherein said delivery is initiated to at least some of the set of subscribers at different times in order to comply with the message delivery requirement.

12. The computer program product of claim 11, wherein the published message includes a firmware update, and wherein the method further comprises:
comparing the published message with subscription information to identify a set of subscribers to receive the published message; and
performing phased distribution of the published message.

13. The computer program product of claim 11, wherein the method further comprises:
determining whether a predetermined percentage of subscribers in a publish/subscribe messaging network has rebooted their computers within a predefined time period; and
in response to determining that the predetermined percentage of subscribers in a publish/subscribe messaging network has not rebooted their computers within the predefined time period, cancelling delivery of the published message to subscribers for which message delivery has not yet successfully completed.

14. The computer program product of claim 11, wherein the method further comprises:
further controlling the delivery of the published message to each of the plurality of subscribers in accordance with a loading level of the publish/subscribe messaging network, wherein a rate of attempted delivery of the published message to different subscribers increases in response to the messaging network having spare capacity beyond a predetermined level, and wherein a rate of attempted delivery of the published message to different subscribers decreases in response to the messaging network having spare capacity below the predetermined level.

15. The computer program product of claim 11, wherein the message delivery requirement defines a deadline for delivering the published message to all of the plurality of subscribers.

16. A computer system comprising:
a processor, a computer readable memory, and a computer readable storage medium;
first program instructions to receive a message delivery requirement for a published message, wherein the message delivery requirement describes delivery parameters for each of a plurality of subscribers in a publish/subscribe messaging network; and
second program instructions to control a delivery of the published message to each of the plurality of subscribers in accordance with the message delivery requirement, wherein said delivery is initiated to at least some of the set of subscribers at different times in order to comply with the message delivery requirement; and wherein
said first and second program instructions are stored on said computer readable storage medium for execution by said processor via said computer readable memory.

17. The computer system of claim 16, wherein the published message includes a firmware update, and wherein the computer system further comprises:
third program instructions to compare the published message with subscription information to identify a set of subscribers to receive the published message; and
fourth program instructions to perform phased distribution of the published message; and wherein
said third and fourth program instructions are stored on said computer readable storage medium for execution by said processor via said computer readable memory.

18. The computer system of claim 16, further comprising:
third program instructions to determine whether a predetermined percentage of subscribers in a publish/subscribe messaging network has rebooted their computers within a predefined time period; and
fourth program instructions to, in response to determining that the predetermined percentage of subscribers in a publish/subscribe messaging network has not rebooted their computers within the predefined time period, cancel delivery of the published message to subscribers for which message delivery has not yet successfully completed; and wherein
said third and fourth program instructions are stored on said computer readable storage medium for execution by said processor via said computer readable memory.

19. The computer system of claim 16, further comprising:
third program instructions to further control the delivery of the published message to each of the plurality of subscribers in accordance with a loading level of the publish/subscribe messaging network, wherein a rate of attempted delivery of the published message to different subscribers increases in response to the messaging network having spare capacity beyond a predetermined level, and wherein a rate of attempted delivery of the published message to different subscribers decreases in response to the messaging network having spare capacity below the predetermined level; and wherein
said third program instructions are stored on said computer readable storage medium for execution by said processor via said computer readable memory.

20. The computer system of claim 16, wherein the message delivery requirement defines a deadline for delivering the published message to all of the plurality of subscribers.
